(19) United States
(12) Patent Application Publication
(10) Pub. No.: US 2013/0038695 A1
(43) Pub. Date: Feb. 14, 2013

(54) PLAYBACK APPARATUS, DISPLAY APPARATUS, RECORDING APPARATUS AND STORAGE MEDIUM

(71) Applicant: Ken Mashitani, Neyagawa-shi (JP)

(72) Inventor: Ken Mashitani, Neyagawa-shi (JP)

(73) Assignee: SANYO ELECTRIC CO., LTD., Moriguchi City (JP)

(21) Appl. No.: 13/695,010

(22) PCT Filed: Apr. 27, 2011
(86) PCT No.: PCT/JP2011/060309

§ 371 Date: Oct. 26, 2012

(30) Foreign Application Priority Data
Apr. 30, 2010 (JP) 2010-105534

(51) Int. Cl. H04N 13/04; H04N 13/02; G06T 15/00

(52) U.S. Cl. 348/46; 348/51; 348/E05.024; 348/E13.026

(57) ABSTRACT

A terminal device (10) plays back a 3D image composed of a plurality of viewpoint images. The terminal device (10) is provided with: an assessment unit (16) that assesses whether it is possible to properly display a 3D image on the basis of whether authentication date and time information which has had the suitability of the 3D view between a plurality of viewpoint images authenticated has been allocated to 3D image data for constructing a 3D image; and a control unit (17) that controls the playback of the 3D image according to the assessment results of the assessment unit (16).

### TECHNICAL FIELD

The present invention relates to a playback apparatus that plays back a stereoscopic image formed of multiple viewpoint images, a display apparatus that displays a stereoscopic image, a recording apparatus that records stereoscopic image data forming a stereoscopic image, and a storage medium that stores stereoscopic image data.

### BACKGROUND ART

Conventionally, a stereoscopic image formed of multiple viewpoint images has been known. There is a parallax between the multiple viewpoint images. Here, in the respective viewpoint images, photographic subjects are captured by image capturing apparatuses that are disposed in a plurality of viewpoint positions (such as a left-eye viewpoint position and a right-eye viewpoint position). The stereoscopic image does not provide stereo vision using the multiple viewpoint images if the viewpoint images are not displayed in accordance with the viewpoint positions.

Accordingly, a technique has been proposed. This technique assigns data forming the respective viewpoint images (hereinafter referred to as viewpoint image data) with viewpoint information indicative of the viewpoint positions of the viewpoint images (for example, refer to Patent Literature 1).

A user may arbitrarily edit the viewpoint image data. In this case, editing work of the user may ruin stereo vision of the multiple viewpoint images. That is, the editing work of the user may lose stereoscopic compatibility between the multiple viewpoint images.

For example, the viewpoint information assigned to the viewpoint image may indicate a position different from a correct viewpoint position. Alternatively, between the multiple viewpoint images, pixels (corresponding pixels) corresponding to one another may have different values of luminance and colors. Alternatively, the corresponding pixels may be misaligned in a vertical direction. Alternatively, a parallax between the multiple viewpoint images may be a parallax that does not allow stereo vision. Note that a parallax that allows stereo vision varies depending on a display size of the multiple viewpoint images.

However, in the aforementioned technique, sufficient attention is not paid to possibility that the user arbitrarily edits the viewpoint image data.

### CITATION LIST

### Patent Document

[Patent Literature 1] Japanese Patent Application Publication No. 2002-287247

### SUMMARY OF THE INVENTION

A playback apparatus according to a first feature plays back a stereoscopic image formed of multiple viewpoint images. The playback apparatus comprises: a determining unit (determining unit 16) that determines whether or not the stereoscopic image is possible to be appropriately displayed based on whether or not authenticated date and time information is assigned to stereoscopic image data forming the stereoscopic image, the authenticated date and time information being indicative of date and time when the stereoscopic compatibility between the multiple viewpoint images is authenticated; and a control unit (control unit 17) that controls playback of the stereoscopic image corresponding to a determination result of the determining unit.

In the first feature, the determining unit determines whether or not the stereoscopic image is possible to be appropriately displayed based on whether or not date and time specified by edited date and time information indicative of date and time when the stereoscopic image data is edited exists after date and time specified by the authenticated date and time information. The viewpoint image data is assigned with at least the authenticated date and time information.

In the first feature, the control unit performs a normal playback process in a case where the stereoscopic image is determined to be possible to be appropriately displayed. The control unit performs an alternative playback process that is different from the normal playback process in a case where the stereoscopic image is determined to be impossible to be appropriately displayed.

In the first feature, the alternative playback process includes at least one process of shrinking the stereoscopic image more than the normal playback process and playing back the shrunk stereoscopic image; playing back a two-dimensional image; and playing back a warning message.

A display apparatus according to a second feature displays a stereoscopic image formed of multiple viewpoint images. The display apparatus comprises: a determining unit (determining unit 16) that determines whether or not the multiple viewpoint images have stereoscopic compatibility based on whether or not authenticated date and time information is assigned to stereoscopic image data forming the stereoscopic image, the authenticated date and time information being indicative of date and time when the stereoscopic compatibility between the multiple viewpoint images is authenticated; and a control unit (control unit 17) that controls display of the stereoscopic image corresponding to a determination result of the determining unit.

A recording apparatus according to a third feature records stereoscopic image data for forming a stereoscopic image formed of multiple viewpoint images. The recording apparatus comprises an assignment unit (assignment unit 15) that assigns authenticated date and time information with the stereoscopic image data in a case where stereoscopic compatibility between the multiple viewpoint images is authenticated, the authenticated date and time information being indicative of date and time when the stereoscopic compatibility between the multiple viewpoint images is authenticated.

A storage medium according to a fourth feature stores stereoscopic image data for forming stereoscopic image formed of multiple viewpoint images. The storage medium comprises a storage unit (storage unit 12) that stores the stereoscopic image data assigned with authenticated date and time information, the authenticated date and time information being indicative of date and time when stereoscopic compatibility between the multiple viewpoint images is authenticated.

### BRIEF DESCRIPTION OF THE DRAWINGS

FIG. 1 is a block diagram illustrating a stereo vision system according to a first embodiment.

FIG. 2 is a diagram illustrating a data format according to the first embodiment.

FIG. 3 is a flowchart illustrating an operation of a terminal apparatus 10 according to the first embodiment.

### MODES FOR CARRYING OUT THE INVENTION

A stereo vision system according to embodiments of the present invention will be described below with reference to the drawings. In the following drawings, identical or similar constituents are denoted by identical or similar reference numerals.

### Overview of Embodiment

Firstly, a playback apparatus plays back a stereoscopic image formed of multiple viewpoint images. The playback apparatus comprises: a determining unit that determines whether or not the stereoscopic image is possible to be appropriately displayed based on whether or not authenticated date and time information is assigned to stereoscopic image data forming the stereoscopic image, the authenticated date and time information being indicative of date and time when the stereoscopic compatibility between the multiple viewpoint images is authenticated; and a control unit that controls playback of the stereoscopic image corresponding to a determination result of the determining unit.

Secondly, a display apparatus displays a stereoscopic image formed of multiple viewpoint images. The display apparatus comprises: a determining unit that determines whether or not the multiple viewpoint images have stereoscopic compatibility based on whether or not authenticated date and time information is assigned to stereoscopic image data forming the stereoscopic image, the authenticated date and time information being indicative of date and time when the stereoscopic compatibility between the multiple viewpoint images is authenticated; and a control unit that controls display of the stereoscopic image corresponding to a determination result of the determining unit.

Accordingly, the playback apparatus controls playback of the stereoscopic image corresponding to whether or not the authenticated date and time information is assigned to the stereoscopic image data. Alternatively, the display apparatus controls display of the stereoscopic image corresponding to whether or not the authenticated date and time information is assigned to the stereoscopic image data. This prevents playback (display) of the multiple viewpoint images where stereoscopic compatibility may be ruined.

Thirdly, a recording apparatus according to a third feature records stereoscopic image data for forming a stereoscopic image formed of multiple viewpoint images. The recording apparatus comprises an assignment unit that assigns authenticated date and time information with the stereoscopic image data in a case where stereoscopic compatibility between the multiple viewpoint images is authenticated, the authenticated date and time information being indicative of date and time when the stereoscopic compatibility between the multiple viewpoint images is authenticated.

Fourthly, a storage medium according to a fourth feature stores stereoscopic image data for forming stereoscopic image formed of multiple viewpoint images. The storage medium comprises a storage unit that stores the stereoscopic image data assigned with authenticated date and time information, the authenticated date and time information being indicative of date and time when stereoscopic compatibility between the multiple viewpoint images is authenticated.

Accordingly, the authenticated date and time information is assigned to the stereoscopic image data. This may prevent playback (display) of the multiple viewpoint images where stereoscopic compatibility may be ruined.

### First Embodiment

### (Configuration of a Stereo Vision System)

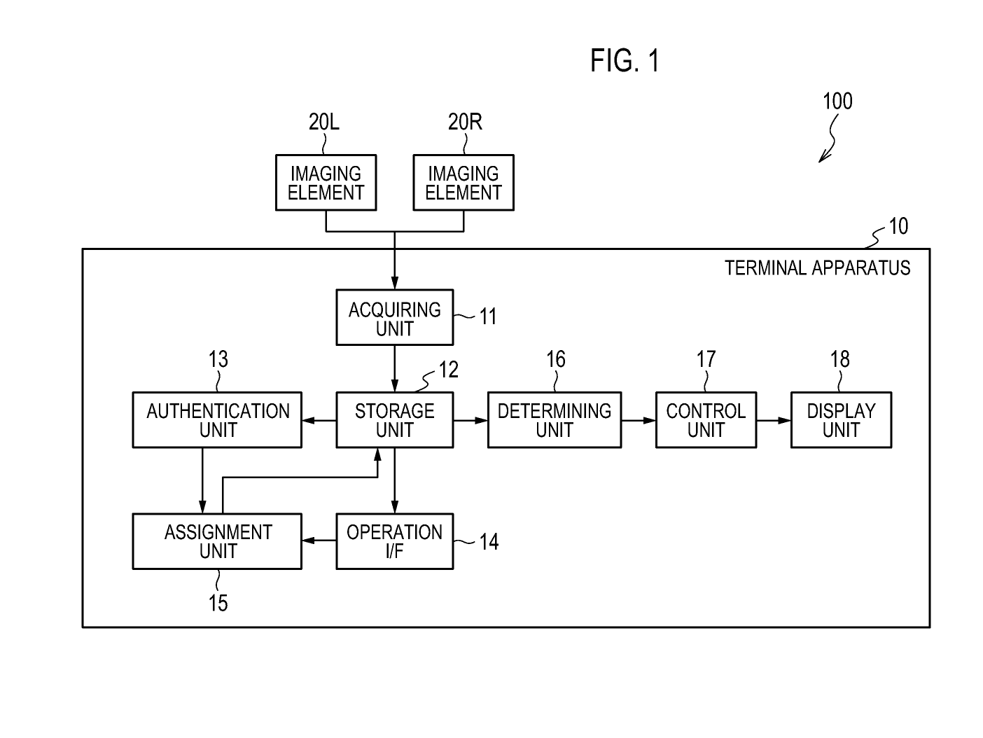

A stereo vision system according to a first embodiment will be described below with reference to the drawings. FIG. 1 is a block diagram illustrating a stereo vision system 100 according to the first embodiment.

As illustrated in FIG. 1, the stereo vision system 100 includes a terminal apparatus 10 and imaging elements 20 (an imaging element 20L and an imaging element 20R).

The terminal apparatus 10 may be an apparatus such as a personal computer, a projector, a digital camera, and a digital TV. In the first embodiment, the terminal apparatus 10 functions as a playback apparatus that plays back a stereoscopic image formed of multiple viewpoint images. The terminal apparatus 10 also functions as a display apparatus that displays a stereoscopic image formed of multiple viewpoint images. The terminal apparatus 10 also functions as a recording apparatus that records stereoscopic image data to form a stereoscopic image. The terminal apparatus 10 also functions as a storage medium that stores stereoscopic image data to form a stereoscopic image.

The terminal apparatus 10 may have the function of the playback apparatus alone. The terminal apparatus 10 may have the function of the display apparatus alone. The terminal apparatus 10 may have the function of the recording apparatus alone. The terminal apparatus 10 may have the function of the storage medium alone.

The imaging element 20 captures a photographic subject. The imaging element 20L is disposed in a left-eye viewpoint position, and captures the photographic subject from the left-eye viewpoint position. Hereinafter, an image captured by the imaging element 20L is referred to as a left-eye viewpoint image. Image data captured by the imaging element 20L is referred to as left-eye viewpoint image data. The imaging element 20R is disposed in a right-eye viewpoint position, and captures the photographic subject from the right-eye viewpoint position. Hereinafter, an image captured by the imaging element 20R is referred to as a right-eye viewpoint image. Image data captured by the imaging element 20R is referred to as right-eye viewpoint image data.

Here, the imaging element 20L and the imaging element 20R may be disposed in a 3D camera for stereoscopic image. Alternatively, the imaging element 20L and the imaging element 20R may be disposed in respective two 2D cameras for two-dimensional image. Alternatively, the imaging element 20L and the imaging element 20R may be one imaging element disposed in one 2D camera for two-dimensional image. Specifically, changing a viewpoint position of the one 2D camera allows the one imaging element in the one 2D camera to function as the imaging element 20L and the imaging element 20R.

As illustrated in FIG. 1, the terminal apparatus 10 includes an acquiring unit 11, a storage unit 12, an authentication unit 13, an operation I/F 14, an assignment unit 15, a determining unit 16, a control unit 17, and a display unit 18.

The acquiring unit 11 acquires captured image data from the imaging element 20. Specifically, the acquiring unit 11 acquires the left-eye viewpoint image data from the imaging element 20L. The acquiring unit 11 acquires the right-eye viewpoint image data from the imaging element 20R.

The storage unit 12 stores the stereoscopic image data formed of the left-eye viewpoint image data and the right-eye viewpoint image data. As described below, in the case where stereoscopic compatibility is authenticated, the storage unit 12 stores the stereoscopic image data to which the authenticated date and time information is assigned. As described below, in the case where the stereoscopic image data is edited, the storage unit 12 stores the stereoscopic image data to which edited date and time information is assigned.

The authentication unit 13 determines whether or not the stereoscopic image data (the left-eye viewpoint image data and the right-eye viewpoint image data) stored in the storage unit 12 has a stereoscopic compatibility. Specifically, the authentication unit 13 determines whether or not stereoscopic compatibility is provided based on: (1) parallax information related to a parallax between the left-eye viewpoint image data and the right-eye viewpoint image data, (2) viewpoint information related to viewpoints of the left-eye viewpoint image data and the right-eye viewpoint image data.

### (1) Authentication of Stereoscopic Compatibility Based on Parallax Information

For example, the parallax information in the left-eye viewpoint image data and the right-eye viewpoint image data includes a parallax (hereinafter referred to as a near maximum parallax) between pixels that express an image in the nearest position in the stereoscopic image. Alternatively, the parallax information in the left-eye viewpoint image data and the right-eye viewpoint image data includes a parallax (hereinafter referred to as a far maximum parallax) between pixels that express an image in a farthest position in the stereoscopic image. Alternatively, the parallax information includes both the near maximum parallax and the far maximum parallax.

Here, the parallax (data parallax) of the image data is a value expressed by the number of pixels, which is a fixed value. In contrast, the parallax (display parallax) of the display image, which is displayed based on the image data, is a value expressed by a unit such as mm, which is variable depending on the size of the display image.

In this case, the authentication unit 13 determines that stereoscopic compatibility is provided, for example, in the case where the near maximum data parallax or the far maximum data parallax is assigned to the stereoscopic image data as parallax information, and authenticates stereoscopic compatibility. Alternatively, the authentication unit 13 determines that stereoscopic compatibility is provided in the case where an upper limit value (or a lower limit value) of display size of the display image, which is determined corresponding to the near maximum data parallax or the far maximum data parallax, is assigned to the stereoscopic image data as parallax information. Thus, the authentication unit 13 authenticates stereoscopic compatibility. The authentication unit 13 determines that stereoscopic compatibility is not provided except these cases.

The near maximum display parallax and the far maximum display parallax are values that are changed corresponding to the display size of the left-eye viewpoint image data and the right-eye viewpoint image data. Generally, in the case where the far maximum display parallax exceeds an interocular distance (approximately 65 mm), stereo vision is not provided. Accordingly, the display size of the left-eye viewpoint image data and the right-eye viewpoint image data may be changed in a range where the far maximum display parallax does not exceed the interocular distance. In this condition, parallax information may be the upper limit value of the display size of the left-eye viewpoint image data and the right-eye viewpoint image data.

### (2) Authentication of Stereoscopic Compatibility Based on Viewpoint Information

The viewpoint information includes information (hereinafter referred to as viewpoint identification information) that indicates whether or not each viewpoint image is data captured from a correct viewpoint position.

In this case, for example, the authentication unit 13 determines that stereoscopic compatibility is provided in the case where the left-eye viewpoint image data is captured from the left-eye viewpoint position while the right-eye viewpoint image is captured from the right-eye viewpoint position. Thus, the authentication unit 13 authenticates stereoscopic compatibility. In the case where it is unknown whether or not each viewpoint image is captured from a correct viewpoint position, the authentication unit 13 determines that stereoscopic compatibility is not provided.

### (3) Others

The stereoscopic compatibility may be determined using information of difference between corresponding pixels in the left-eye viewpoint image data and the right-eye viewpoint image data other than the parallax information and the viewpoint information. For example, the information of difference between corresponding pixels in the left-eye viewpoint image data and the right-eye viewpoint image data may be an average value across the whole screen. This average value may be an average value of luminance difference between representative pixels forming a representative image included in a stereoscopic image, or luminance difference between pixels expressing the same point (hereinafter referred to as corresponding points) between the images. Alternatively, the information of difference between corresponding pixels in the left-eye viewpoint image data and the right-eye viewpoint image data may be the following average value across the whole screen. This average value is an average value of contrast difference between representative pixels forming a representative image included in a stereoscopic image, or contrast difference between pixels expressing corresponding points. Alternatively, the information difference between corresponding pixels in the left-eye viewpoint image data and the right-eye viewpoint image data may be the following average value across the whole screen. This average value is an average value of color difference between representative pixels forming a representative image included in a stereoscopic image, or color difference between pixels expressing corresponding points. Any information of difference between corresponding pixels is possible insofar as the information employs at least one of luminance difference, contrast difference, and color difference. Contrast of each image data is calculated based on at least two pixels in each image data. The at least two pixels are selected in accordance with a predetermined rule. For example, the at least two pixels are two pixels adjacent to one another.

In this case, for example, the authentication unit 13 determines that stereoscopic compatibility is provided in the case where the luminance difference between the representative pixels is within a predetermined threshold value. Thus, the authentication unit 13 authenticates stereoscopic compatibility. Alternatively, for example, the authentication unit 13 determines that stereoscopic compatibility is provided in the case where the contrast difference between the representative pixels is within a predetermined threshold value. Thus the authentication unit 13 authenticates stereoscopic compatibility. For example, the authentication unit 13 determines that stereoscopic compatibility is provided in the case where the color difference between the representative pixels is within a predetermined threshold value. Thus the authentication unit 13 authenticates stereoscopic compatibility. The authentication unit 13 determines that stereoscopic compatibility is not provided except these cases.

### (4) A Method for Authenticating Compatibility

A method for authenticating stereoscopic compatibility may be a method that is manually performed by a user. The method where the user manually authenticates stereoscopic compatibility is disclosed in, for example, Japanese Unexamined Patent Application Publication No. 2006-072455. Alternatively, the method for authenticating stereoscopic compatibility may be automatically performed by the terminal apparatus 10. The method where the terminal apparatus 10 automatically authenticates stereoscopic compatibility is disclosed in, for example, Japanese Unexamined Patent Application Publication No. 2006-018470. Both the methods authenticate that each viewpoint image is captured from a correct viewpoint position.

Returning to FIG. 1, the operation I/F 14 is a user interface such as a keyboard and a computer mouse. The user uses the operation I/F 14 to edit the stereoscopic image data stored in the storage unit 12. That is, the user uses the operation I/F 14 to edit the left-eye viewpoint image data and the right-eye viewpoint image data. Editing the stereoscopic image data includes, for example, rotating the image, changing compression ratio of the image, and a similar process. Note that editing the stereoscopic image data is performed, for example, using dedicated software and similar software.

The assignment unit 15 assigns the stereoscopic image data with the authenticated date and time information, which indicates date and time when stereoscopic compatibility was authenticated, in the case where stereoscopic compatibility is authenticated in the stereoscopic image data (the left-eye viewpoint image data and the right-eye viewpoint image data). The stereoscopic image data to which the authenticated date and time information is assigned is stored in the storage unit 12.

For example, in the case where the date and time when stereoscopic compatibility was authenticated is at 16:30:25 on 26th February in 2010, “20100226163025” is assigned to stereoscopic image data as the authenticated date and time information.

In the case where the stereoscopic image data (the left-eye viewpoint image data and/or the right-eye viewpoint image data) is edited, the assignment unit 15 assigns the stereoscopic image data with the edited date and time information that indicates date and time when the stereoscopic image data was edited. The stereoscopic image data to which the edited date and time information is assigned is stored in the storage unit 12.

For example, the date and time when the stereoscopic image data was edited is at 19:45:30 on 27th February in 2010, “20100227194530” is assigned to the stereoscopic image data as the edited date and time information.

The determining unit 16 determines whether or not it is possible to appropriately display the stereoscopic image based on whether or not the authenticated date and time information is assigned to the stereoscopic image data. For example, the determining unit 16 determines that it is possible to appropriately display the stereoscopic image in the case where the authenticated date and time information is assigned to the stereoscopic image data. The determining unit 16 determines that it is not possible to appropriately display the stereoscopic image in the case where the authenticated date and time information is not assigned to the stereoscopic image data.

Additionally, the determining unit 16 may determine whether or not date and time specified by the edited date and time information exists after date and time specified by the authenticated date and time information. Specifically, the determining unit 16 determines that it is possible to appropriately display the stereoscopic image in the case where the date and time specified by the edited date and time information does not exist after the date and time specified by the authenticated date and time information. The determining unit 16 determines that it is not possible to appropriately display the stereoscopic image in the case where the date and time specified by the edited date and time information exists after the date and time specified by the authenticated date and time information.

The control unit 17 controls playback of the stereoscopic image based on the determination result of the determining unit 16. Specifically, the control unit 17 performs a normal playback process in the case where it is determined that it is possible to appropriately display the stereoscopic image. In contrast, the control unit 17 performs an alternative playback process that is different from the normal playback process in the case where it is determined that it is not possible to appropriately display the stereoscopic image.

Here, the normal playback process is a process for playing back the stereoscopic image as usual based on the stereoscopic image data stored in the storage unit 12.

In contrast, the alternative playback process is at least one process of a process that shrinks the stereoscopic image more than the normal playback process and then plays back the stereoscopic image, a process that plays back the two-dimensional image, and a process that plays back a warning message.

For example, in the case where a display parallax amount exceeds an upper limit while the normal playback process is being performed, the control unit 17 shrinks the stereoscopic image more than the normal playback process and then plays back the stereoscopic image.

Alternatively, in the case where the luminance difference, the contrast difference, or the color difference exceeds a predetermined threshold value, the control unit 17 plays back the two-dimensional image. For example, the control unit 17 plays back the two-dimensional image based on any one of the left-eye viewpoint image data and the right-eye viewpoint image data.

Alternatively, the control unit 17 may shrink the stereoscopic image more than the normal playback process while playing back the warning message, and then plays back the stereoscopic image. The control unit 17 may plays back the two-dimensional image along with the warning message. Alternatively, the control unit 17 may display the warning message alone. The control unit 17 may display the warning message along with the stereoscopic image of the normal playback process.

The display unit 18 is a display such as a liquid crystal panel that displays the stereoscopic image, and displays an image in accordance with the control of the control unit 17. For example, the display unit 18 allows displaying the stereoscopic image in accordance with the normal playback process. Alternatively, the display unit 18 displays an image in accordance with the alternative playback process.

### (Data Format)

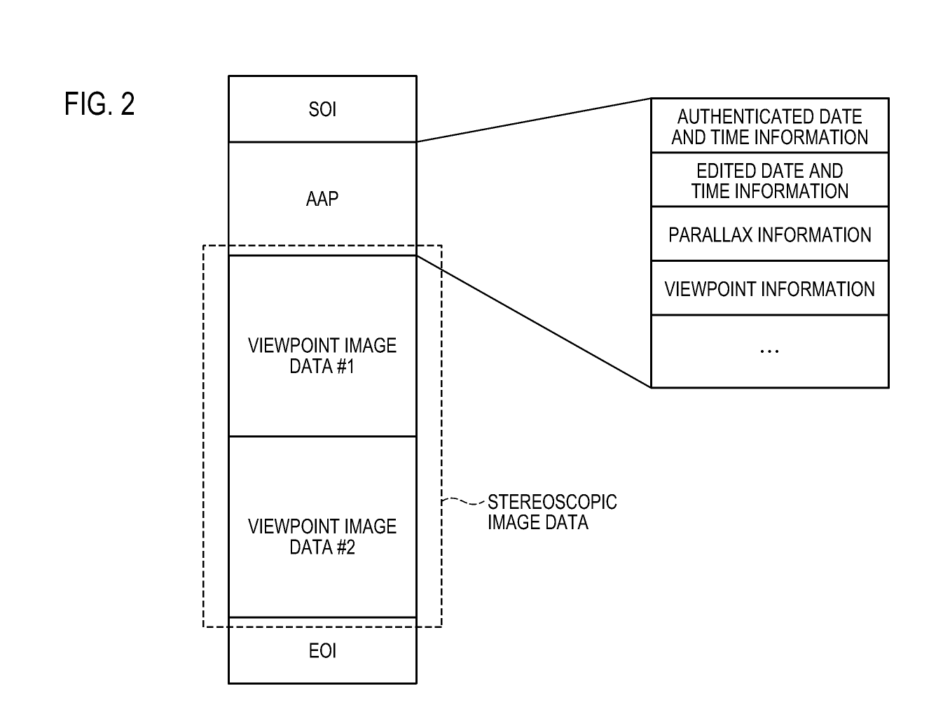

A data format according to the first embodiment will be described below with reference to the drawings. FIG. 2 is a diagram illustrating a data format according to the first embodiment. FIG. 2 illustrates an exemplary data format of JPEG format.

As illustrated in FIG. 2, the JPEG format has data including “SOI”, “APP”, “stereoscopic image data”, and “EOI”. The data is stored in the storage unit 12.

“SOI” is a pointer (Start of Image) that indicates a starting point of the data. “EOI” is a pointer (End of Image) that indicates an ending point of the data. The stereoscopic image data include, as described above, the left-eye viewpoint image data (viewpoint image data #1) and the right-eye viewpoint image data (viewpoint image data #2).

“APP” is a region (Application Marker Segment) that stores information related to the stereoscopic image data. As described above, the authenticated date and time information and the edited date and time information are assigned to “APP”. As described above, the parallax information and the viewpoint information are also assigned to “APP”. “APP” may store diaphragm, shutter speed, and similar information in addition to these kinds of information. The JPEG format is disclosed in, for example, Japanese Unexamined Patent Application Publication No. 2007-18078.

### (Operation of the Terminal Apparatus)

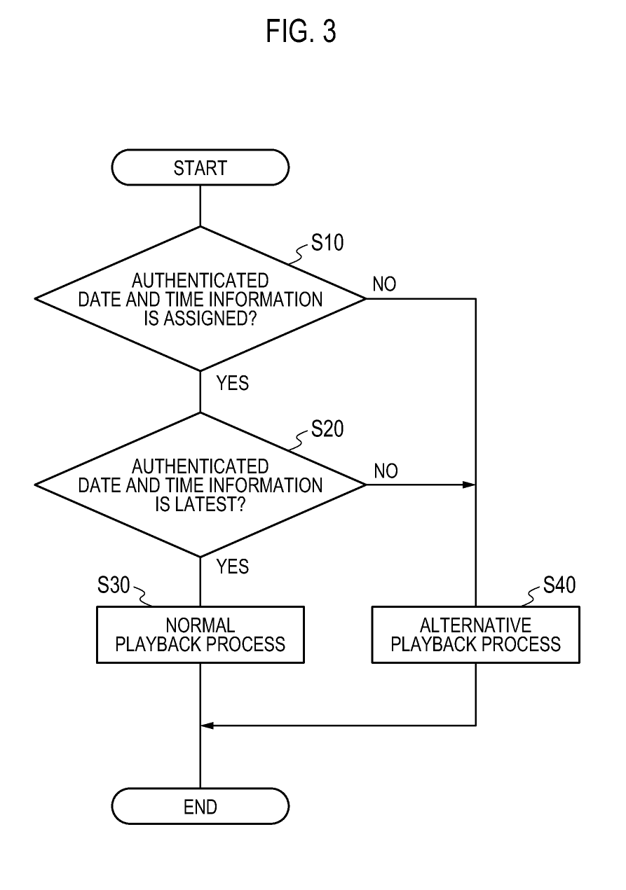

Operation of the terminal apparatus according to the first embodiment will be described below with reference to the drawings. FIG. 3 is a flowchart illustrating an operation of the terminal apparatus 10 according to the first embodiment.

Here, a description will be given of an exemplary where the terminal apparatus 10 functions as a playback apparatus (or a display apparatus).

As illustrated in FIG. 3, at Step 10, the terminal apparatus 10 determines whether or not the authenticated date and time information is assigned to the stereoscopic image data. In the case where the authenticated date and time information is assigned to the stereoscopic image data, the terminal apparatus 10 proceeds to a process of Step 20. In contrast, in the case where the authenticated date and time information is not assigned to the stereoscopic image, the terminal apparatus 10 proceeds to a process of Step 40.

At Step 20, the terminal apparatus 10 determines whether or not the date and time specified by the edited date and time information exists after the date and time specified by the authenticated date and time information. In the case where the date and time specified by the edited date and time information does not exist after the date and time specified by the authenticated date and time information, the terminal apparatus 10 proceeds to a process of Step 30. In contrast, in the case where the date and time specified by the edited date and time information exists after the date and time specified by the authenticated date and time information, the terminal apparatus 10 proceeds to the process of Step 40.

At Step 30, the terminal apparatus 10 performs the normal playback process. Specifically, the terminal apparatus 10 plays back the stereoscopic image based on the stereoscopic image data as usual.

At Step 40, the terminal apparatus 10 performs the alternative playback process different from the normal playback process. Specifically, the terminal apparatus 10 performs at least one process of a process that shrinks the stereoscopic image more than the normal playback process and then plays back the stereoscopic image, a process that plays back the two-dimensional image, and a process that plays back the warning message.

### (Operation and Effect)

In the first embodiment, the terminal apparatus 10 functions as a playback apparatus that controls playback of the stereoscopic image corresponding to whether or not the authenticated date and time information is assigned to the stereoscopic image data. Alternatively, the terminal apparatus 10 functions as a display apparatus that controls display of the stereoscopic image corresponding to whether or not the authenticated date and time information is assigned to the stereoscopic image data. Accordingly, this prevents playback (display) of the multiple viewpoint images where stereoscopic compatibility may be ruined.

In the first embodiment, the terminal apparatus 10 functions as a recording apparatus that assigns the stereoscopic image data with the authenticated date and time information in the case where stereoscopic compatibility is authenticated. Alternatively, the terminal apparatus 10 functions as a storage medium that stores the stereoscopic image data to which the authenticated date and time information is assigned. Accordingly, this prevents playback (display) of the multiple viewpoint images where stereoscopic compatibility may be ruined.

In the first embodiment, the terminal apparatus 10 controls playback or display of the stereoscopic image based on whether or not the date and time specified by the edited date and time information exists after the date and time specified by the authenticated date and time information. Accordingly, this prevents playback (display) of the multiple viewpoint images where stereoscopic compatibility may be ruined.

In the first embodiment, the terminal apparatus 10 performs the alternative playback process different from the normal playback process in the case where it is determined that the stereoscopic image might not be appropriately displayed. This reduces possibility that the user watches the stereoscopic image without being aware of ruined stereoscopic compatibility. That is, this reduces eyestrain of the user.

### Other Embodiments

As described above, the details of the present invention have been disclosed by using the embodiment of the present invention. However, it should not be understood that the description and drawings which constitute a part of this disclosure limit the present invention. From this disclosure, various alternative embodiments, examples, and operation techniques will be easily found by those skilled in the art.

In the embodiment, the example is given of a case where the multiple viewpoint images forming the stereoscopic image are the left-eye viewpoint image and the right-eye viewpoint image. However, the embodiment is not limited to this. For example, the multiple viewpoint images may include equal to or more than three viewpoint images.

While not specifically mentioned in the embodiment, it is difficult for a user to move two eyeballs outside at the same time. Therefore, note that the far maximum parallax is more important than the near maximum parallax.

While not specifically mentioned in the embodiment, the terminal apparatus 10 (the display unit 18) may display a result (level information) where the luminance difference, the contrast difference, or the color difference is classified into a plurality of levels. Note that the luminance difference, the contrast difference, or the color difference is an average value of difference between representative pixels forming a representative image included in a stereoscopic image, or luminance difference between pixels expressing corresponding points, across the whole screen in the left-eye viewpoint image data and the right-eye viewpoint image data as described above.

While not specifically mentioned in the embodiment, the terminal apparatus 10 (the authentication unit 13) may determine that stereoscopic compatibility is provided in the case where a value indicating the luminance difference, the contrast difference, or the color difference is assigned to the stereoscopic image data, and then authenticate stereoscopic compatibility. Alternatively, the terminal apparatus 10 (the authentication unit 13) may determine that stereoscopic compatibility is provided in the case where the stereoscopic image data is assigned with the result (the level information) where the luminance difference, the contrast difference, or the color difference is classified into the plurality of levels, and then authenticate stereoscopic compatibility.

An authentication tag indicating that the luminance difference is authenticated, an authentication tag indicating that the contrast difference is authenticated, and an authentication tag indicating that the color difference is authenticated may be separately assigned to stereoscopic image data. Additionally, an authentication tag indicating that assignment of the parallax information is authenticated, and an authentication tag indicating that assignment of the correct viewpoint information may be separately assigned to the stereoscopic image data. Assignment of the luminance difference, the contrast difference, the color difference, the parallax information, the correct viewpoint information, or similar information may be separately authenticated.

While not specifically mentioned in the embodiment, the imaging element 20L and the imaging element 20R may be disposed in a dedicated image capturing apparatus for capturing the stereoscopic image. The terminal apparatus 10 (the authentication unit 13) may immediately determine that stereoscopic compatibility is provided in the case where the dedicated image capturing apparatus for capturing the stereoscopic image acquires the stereoscopic image data, and then authenticate stereoscopic compatibility. Alternatively, in this case, the terminal apparatus 10 (the authentication unit 13) may determine stereoscopic compatibility is provided after the luminance difference, the contrast difference, or the color difference is confirmed to be within a predetermined threshold value, and then authenticate stereoscopic compatibility.

In the case where the imaging element 20L and the imaging element 20R are disposed in the dedicated image capturing apparatus for capturing the stereoscopic image, the dedicated image capturing apparatus for capturing the stereoscopic image may have a function that determines that stereoscopic compatibility is provided, and authenticates stereoscopic compatibility. That is, the dedicated image capturing apparatus may have a function that assigns the stereoscopic image data with an authentication tag indicating that stereoscopic compatibility is authenticated. Alternatively, the dedicated image capturing apparatus may have a function that assigns the stereoscopic image data with the near maximum data parallax or the far maximum data parallax as the parallax information. Alternatively, the dedicated image capturing apparatus may have a function that assigns the stereoscopic image data with the luminance difference, the contrast difference, or the color difference as information.

In the embodiment, a geographical area (hereinafter referred to as authentication area) where stereoscopic compatibility was authenticated and a geographical area (edit area) where the stereoscopic image data was edited are not specifically mentioned. However, a time lag between the authentication area (such as Tokyo) and the edit area (such as Los Angeles) may be considered. That is, the terminal apparatus 10 (the assignment unit 15) may assign the stereoscopic image data with the edited date and time information after time in the edit area is converted into standard time in an authentication area. Alternatively, the terminal apparatus 10 (the assignment unit 15) may assign the stereoscopic image data with the authenticated date and time information and edited date and time information after time in the authentication area and time in the edit area are converted into standard time in a predetermined area.

Additionally, the terminal apparatus 10 (the assignment unit 15) may assign the stereoscopic image data with area information that specifies the authentication area and area information that specifies the edit area.

In the embodiment, the terminal apparatus 10 has all of the function of the playback apparatus, the function of the display apparatus, the function of the recording apparatus, and the function of the storage medium. However, the embodiment is not limited to this. In the case where the terminal apparatus 10 functions as the playback apparatus, any configuration is possible insofar as the terminal apparatus 10 includes at least the determining unit 16 and the control unit 17. In the case where the terminal apparatus 10 functions as the display apparatus, any configuration is possible insofar as the terminal apparatus 10 includes at least the determining unit 16, the control unit 17, and the display unit 18. In the case where the terminal apparatus 10 functions as the recording apparatus, any configuration is possible insofar as the terminal apparatus 10 includes at least the assignment unit 15. In the case where the terminal apparatus 10 functions as the storage medium, any configuration is possible insofar as the terminal apparatus 10 includes at least the storage unit 12.

In addition, the entire content of Japanese Patent Application No. 2010-105534 (filed on Apr. 30, 2010) is incorporated in the present specification by reference.

### INDUSTRIAL APPLICABILITY

This application provides a playback apparatus, a display apparatus, a recording apparatus, and a storage medium that prevent playback of multiple viewpoint images where stereoscopic compatibility may be ruined and a similar process.

1. A playback apparatus for playing back a stereoscopic image formed of multiple viewpoint images, the playback apparatus comprising:
a determining unit that determines whether or not the stereoscopic image is possible to be appropriately displayed based on whether or not authenticated date and time information is assigned to stereoscopic image data forming the stereoscopic image, the authenticated date and time information being indicative of date and time when the stereoscopic compatibility between the multiple viewpoint images is authenticated; and
a control unit that controls playback of the stereoscopic image corresponding to a determination result of the determining unit.

2. The playback apparatus according to claim 1, wherein
the determining unit determines whether or not the stereoscopic image is possible to be appropriately displayed based on whether or not date and time specified by edited date and time information indicative of date and time when the stereoscopic image data is edited exists after date and time specified by the authenticated date and time information, and
the viewpoint image data is assigned with at least the authenticated date and time information.

3. The playback apparatus according to claim 1, wherein
the control unit:
performs a normal playback process in a case where the stereoscopic image is determined to be possible to be appropriately displayed; and
performs an alternative playback process that is different from the normal playback process in a case where the stereoscopic image is determined to be impossible to be appropriately displayed.

4. The playback apparatus according to claim 1, wherein
the alternative playback process includes at least one process of
shrinking the stereoscopic image more than the normal playback process and playing back the shrunk stereoscopic image;
playing back a two-dimensional image; and
playing back a warning message.

5. A display apparatus for displaying a stereoscopic image formed of multiple viewpoint images, the display apparatus comprising:
a determining unit that determines whether or not the multiple viewpoint images have stereoscopic compatibility based on whether or not authenticated date and time information is assigned to stereoscopic image data forming the stereoscopic image, the authenticated date and time information being indicative of date and time when the stereoscopic compatibility between the multiple viewpoint images is authenticated; and
a control unit that controls display of the stereoscopic image corresponding to a determination result of the determining unit.

6. A recording apparatus for recording stereoscopic image data for forming a stereoscopic image formed of multiple viewpoint images, the recording apparatus comprising
an assignment unit that assigns authenticated date and time information with the stereoscopic image data in a case where stereoscopic compatibility between the multiple viewpoint images is authenticated, the authenticated date and time information being indicative of date and time when the stereoscopic compatibility between the multiple viewpoint images is authenticated.

7. A storage medium for storing stereoscopic image data for forming stereoscopic image formed of multiple viewpoint images, the storage medium comprising
a storage unit that stores the stereoscopic image data assigned with authenticated date and time information, the authenticated date and time information being indicative of date and time when stereoscopic compatibility between the multiple viewpoint images is authenticated.
